(19) United States
(12) Patent Application Publication
(10) Pub. No.: US 2010/0148731 A1
(43) Pub. Date: Jun. 17, 2010

(54) METHOD AND CHARGER FOR BOOST CHARGING A CHARGEABLE BATTERY ON THE BASIS OF A PHYSICAL MODEL

(75) Inventors: Peter Notten, Eindhoven (NL); Hendrik Johannes Bergveld, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,505

(22) PCT Filed: Jun. 23, 2006
(86) PCT No.: PCT/IB2006/052048

§ 371 Date: Dec. 21, 2007

(30) Foreign Application Priority Data
Jun. 30, 2005 (EP) 05105943.4

(51) Int. Cl. H02J 7/04

(52) U.S. Cl. 320/162

(57) ABSTRACT

The invention relates to a method of charging a rechargeable unit, such as a rechargeable battery or a rechargeable battery pack, wherein the charging current is larger than the nominal charging current (C) if at least one condition in the rechargeable unit is met, and wherein the at least one condition is continuously calculated from measurable variables of the rechargeable unit through a physics-based model. The invention also relates to a corresponding method. The features of the invention allow a continuous monitoring of the variables in the battery, so that a proper criterion is available for the decision if charging with high charge current is allowable without a reduction of the lifetime of the battery.

The present invention relates to the recharging of a rechargeable unit such as a rechargeable battery or a rechargeable battery pack.

The majority of battery-powered portable devices use of Li-ion batteries as the energy source, as batteries of the kind can store a significant amount of energy in a modest volume and weight. The invention relates to such batteries in so far that the advantages of the invention appear very clearly with batteries of this kind. The invention is, however, also applicable to rechargeable batteries of other kinds like but not exclusively Ni-based batteries.

Conventionally, Li-ion batteries are charged according to the CCCV-regime. In this regime the battery is initially charged with a constant current (CC-regime, constant current). Herein the battery voltage slowly increases. The moment the battery voltage reaches a predetermined value, for instance 4.1 V or 4.2 V, the regime is amended to charging with a constant voltage (CV-regime, constant voltage) and a decreasing current. This CCCV-charging regime has been optimized for capacity and cycle life of the battery. However the charging times are relatively long, e.g. about 2 hours.

There is a need for chargers allowing a shorter charging time, especially from a commercial point of view. EP-A-1 516 405 discloses a charger wherein the charging current is increased to a value greater than twice the nominal charging current during the initial stage of the CCCV charging regime. This increased charging current allows a shorter charge time. Indeed it has appeared that during the initial stage these higher values of the charging current have no detrimental effect on the life cycle of the Li-ion batteries. However, care must be taken to stop this boost charging process and resume the ‘normal’ CCCV-charging regime timely, before damage is done to the battery. Chargers adapted for this regime are therefore adapted to stop boost charging well before any chances of damaging the battery are reached to be on the safe side and to avoid shorting of the life cycle.

Nevertheless, there is a need for a further reduction of the charge time. The object of the invention is to provide a method and a charger allowing a shorter charge time.

This object is achieved by a method of charging a rechargeable unit, such as a rechargeable battery or a rechargeable battery pack, wherein the charging current is larger than the nominal charging current (C) if at least one condition in the rechargeable unit is met, wherein the at least one condition is continuously calculated from measurable variables of the rechargeable unit through a physics-based model.

This aim is also reached by a charger for charging a rechargeable unit, such as a rechargeable battery or a rechargeable battery pack, wherein the charger comprises a supply unit adapted to supply a charging current to the rechargeable unit and a controller for controlling the charging current, wherein the controller is adapted to have the supply unit supply a charging current larger than the nominal charging current (C) if at least one condition in the rechargeable unit is met, the charger comprising measuring means for measuring measurable variables of the battery and modeling means adapted to calculate continuously said at least one condition from said measured variables.

Shortening of the life cycle of the battery occurs when the battery is charged with high currents when certain variables in the battery are within certain areas. When these areas are avoided during the charging with the high currents, the high charge currents can be used without shortening the life cycle, allowing a substantial reduction of the charge time.

The features of the invention allow a continuous monitoring of the variables in the battery, so that a proper criterion is available for the decision if charging with a high charge current is allowable without a reduction of the lifetime of the battery. Herein it is noted that in the prior-art method and charger according to EP-A-1 516 405, the same criterion is used but that this criterion has been fixed during the production of the charger. In this prior art no continuous updating of the variable takes place.

Rather the present invention provides a continuous updating of the value or variable used in the determination process, so that a much more adequate assessment of the situation in the battery can be made, allowing to make the safety margin between the value at which the boost charging is switched over to normal charging much closer to the value of the variable in the battery at which the reduction of the life time starts. This allows a longer boost charging and hence a shorter overall charge time.

Further it is noted that the main application of the invention resides in Li-ion batteries. The invention is, however, also applicable to batteries of other kinds.

It is known that an important cause of capacity loss is degradation of the positive electrode due to the Li-ion concentration at the electrode surface dropping below a certain level. Below this level of concentration the electrode material decomposes, which is a non-reversible process leading to a permanent decrease in maximum battery capacity. For example, this concentration level is 0.5 for a positive LiCoO₂ electrode, meaning that half of the possible sites for Li-intercalation are occupied with Li-ions. For a lower occupancy level decomposition of the electrode material occurs.

This implies that the concentration of the Li-ons at the electrode surface is an important criterion for the decision when the boost charge procedure should be switched over to the ‘normal’ CCCV-regime.

According to a preferred embodiment a method is provided wherein one of said conditions is the Li-ion concentration at the positive LiCoO₂-electrode surface (X_{Li,pos,surf}) and the charging current is controlled to be larger than the nominal charging current (C) if the Li-ion concentration at the positive LiCoO₂-electrode surface (X_{Li,pos,surf}) is larger than 0.5.

It is, however, noted that the features of the invention relating to the application thereof to batteries with LiCoO₂-electrodes may well be applicable to batteries with other electrodes of the Li-ion type, such as LiMiO₂, LiMnO₂, or mixtures thereof such as LiMi.₃Co.3Mn.3O2, but also LiMn₂O₂ and LiFePO₄. Adaptation of certain values used in the invention may have to be effected as a consequence of these other materials.

It is, however, also noted that other materials than the anode materials may be used; the invention is also applicable to other anode materials like Si. It is important that the anode material forms an SEI.

The feature of this embodiment applies also to a charger of the kind referred to above wherein the modeling means are adapted to model the Li-ion concentration at the positive LiCoO₂-electrode surface (X_{Li,pos,surf}) and that the controller is adapted to have the supply unit supply a charging current larger than the nominal charging current (C) if the Li-ion concentration at the positive LiCoO₂-electrode surface (X_{Li,pos,surf}) is larger than 0.5.

When the surface concentration of Li-ions in the positive electrode is continuously calculated during charging, the voltage used in the boost charging regime and the duration of this regime can be optimized such that this concentration never drops below a predetermined level, e.g. 0.5 for a Li-ion electrode. The main advantage is that boost charging always occurs under optimal conditions and that detrimental effects, which have been demonstrated to be the same as for normal CCCV charging, occur even less than for normal charging. This means that apart from enabling a very fast recharge of battery capacity, the amount of recharged capacity is maximized while detrimental effects are prevented.

Another source of irreversible capacity loss of a Li-ion battery is the formation of an SEI (Solid Electrolyte Interface) layer on the negative electrode. This layer takes up Li-ions which can afterwards no longer take part in the charge/discharge cycles, leading to a lower battery capacity. A physics-based Li-ion battery model is available that is able to calculate the formation of an SEI layer based on the conditions under which the battery is used.

Therefore, another preferred embodiment of the invention provides the method wherein one of said conditions is the thickness of the SEI layer at the negative electrode (d_{SEI}) and that the charging current is larger than the nominal charging current if the thickness of the SEI layer at the negative electrode (d_{SEI}) is smaller than a predetermined value.

This embodiment also provides a charger of the kind referred to above wherein the modeling means are adapted to model the thickness of the SEI layer at the negative electrode (d_{SEI}) and the controller is adapted to have the supply unit supply a charging current larger than the nominal charging current if the thickness of the SEI layer at the negative electrode (d_{SEI}) is smaller than a predetermined value.

For the algorithm for the prior-art system as described in EP-A-1 516 405 the starting and the stopping SoC (State-of-Charge) have to be determined in an extensive series of measurements before the realization of the product incorporating boost charging. Again it is noted that from these measurements a fixed value for the SoC was determined at which the boost charging process was stopped and normal charging was started.

By using the battery model an up-to-date value of the SoC is instantly available, so that optimum use can be made of the advantages of boost charging.

Consequently, a preferred embodiment of the invention provides a method wherein one of said conditions is the State-of-Charge (SoC) and the charging current is larger than the nominal charging current if the State-of-Charge (SoC) is smaller than a predetermined value.

This embodiment also provides a charger wherein the modeling means are adapted to model the State-of-Charge (SoC) and the controller is adapted to have the supply unit supply a charging current larger than the nominal charging current if the State-of-Charge (SoC) is smaller than a predetermined value.

As the detrimental effects of boost charge are avoided by avoiding the situations under which these adverse effects may develop, the boost charge may be optimized to obtain a maximum effect thereof. This may be accomplished by allowing the maximum value of the charging current.

A preferred embodiment provides the feature that the charging current is determined by the maximum allowable charge voltage of the rechargeable unit if at least one of the conditions is met.

These effects are also obtained by a charger which is adapted to apply the maximum allowable charge voltage of the rechargeable unit if at least one of said conditions is met.

The modeling which forms the base of the present invention may lead to errors in the determination of the values calculated by the model. As the battery itself is present, it is possible to execute measurements on the battery, such as voltage, current and temperature and to compare these measurements with the corresponding values calculated by the model. This allows a comparison and hence an assessment of the accuracy of the model. The assessment of the accuracy or rather of the magnitude of the error of the compared variables may be used in an adaptive updating of the model. It is, however, also possible to use these errors in the boost charge algorithm.

Hence another preferred embodiment provides the feature that from the physics-based model at least one measurable value is determined, that the said value is measured, that the difference between the measured value and the calculated value is determined and that another charge procedure is resumed if the resulting difference exceeds a predetermined value.

This embodiment also provides the feature that the modeling means are adapted to determine at least one measurable variable, that the measuring means are adapted to measure said variable, that the control means are adapted to determine the difference between the measured value and the calculated value and that the control means are adapted to resume another charge procedure if the resulting errors exceed a predetermined value.

Yet another embodiment provides the feature that at least one of the calculated values is used to adapt parameters of the charge process and that the modeling means are provided to adapt parameters of the charge process in dependence on the errors.

The availability of the variables offers the possibility to use these variables for the determination if and when the charge regime should be switched over. It is, however, also possible to use this information to adapt parameters in the process like the supply voltage and the supply current. This adaptation may take place during the normal charge regime but also during the boost charge regime. Again this adaptation allows the possibility to use larger charge currents while at the same time avoiding situations shortening the life cycle of the chargeable unit.

Hereinafter the present invention will be elucidated with the help of the accompanying drawings.

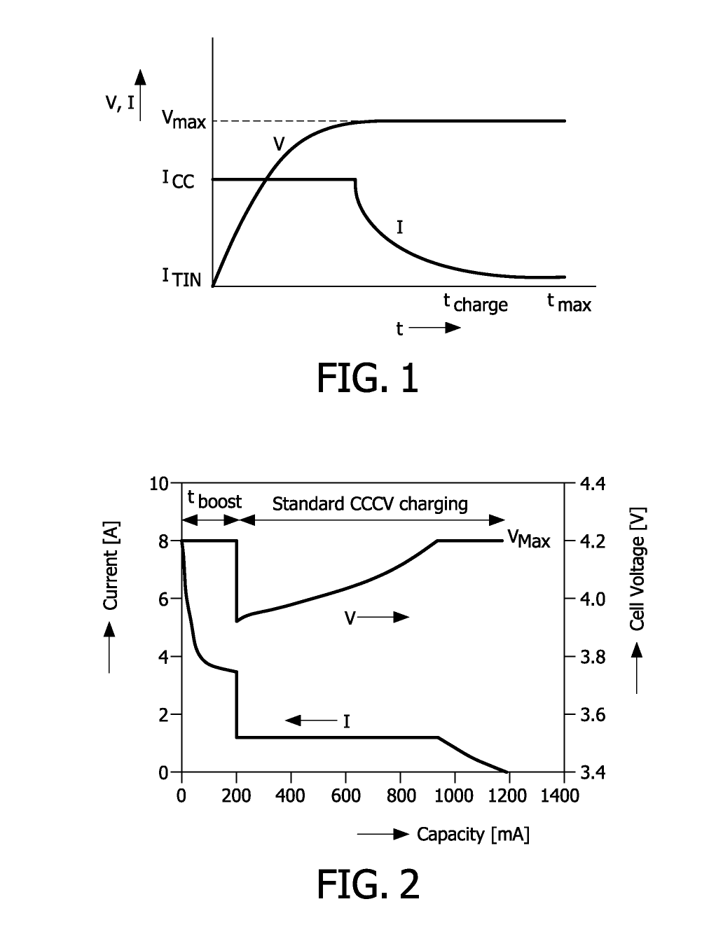

FIG. 1 depicts a diagram showing the charge voltage and charge current in a conventional CCCV-regime;

FIG. 2 depicts a similar diagram wherein the boost charge process is used;

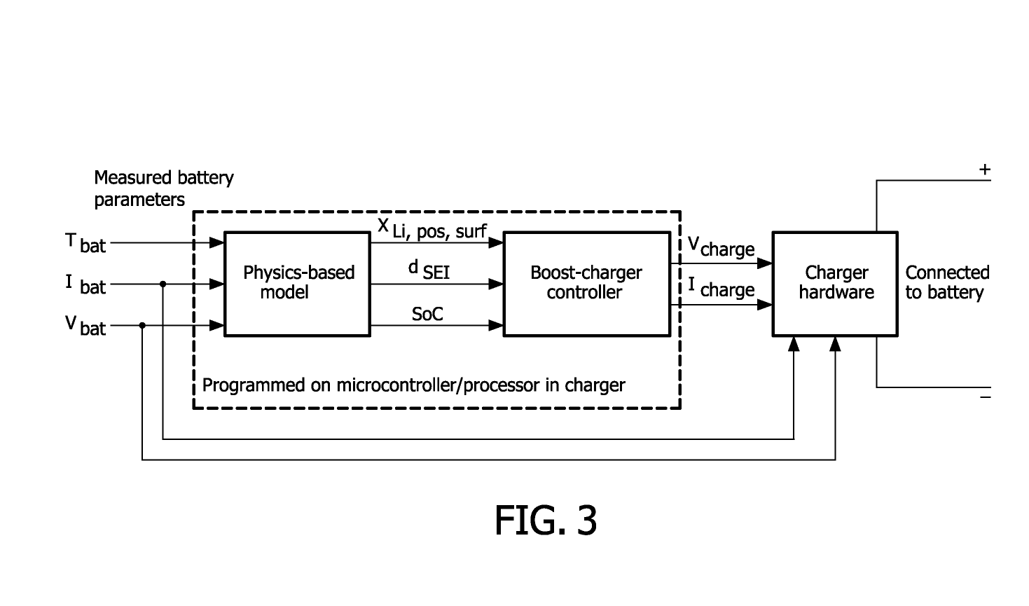

FIG. 3 shows a block diagram of the charger according to the invention;

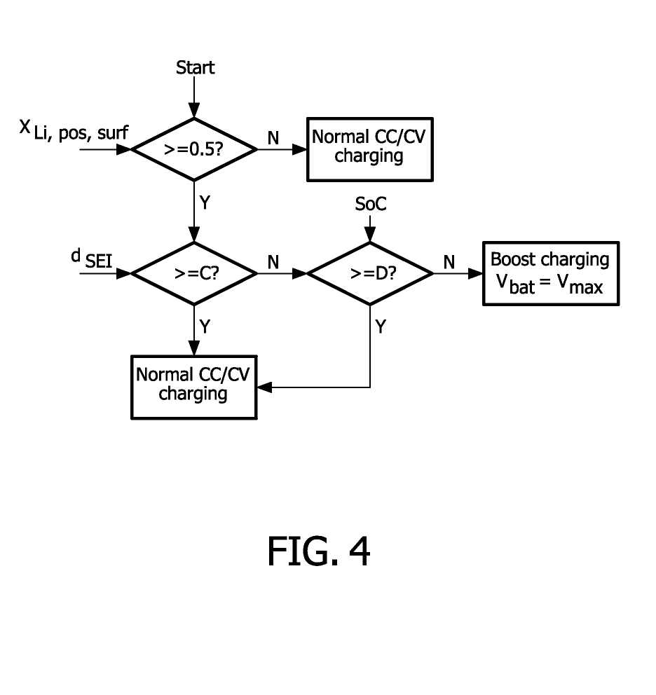

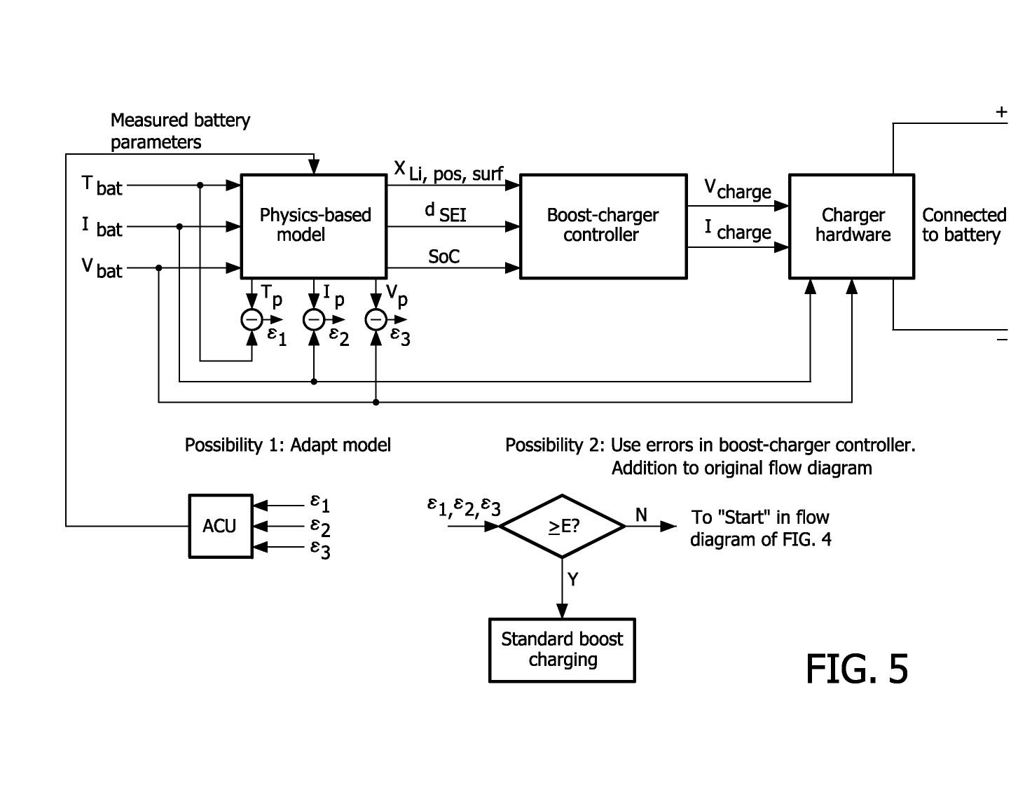

FIG. 4 shows a flow chart used within the controller in the charger according to the invention; and

FIG. 5 shows a variation of the block diagram according to the invention.

In FIG. 1 the prior art CCCV-charging regime is shown. Initially the charging takes place by a constant current. The magnitude of the current is chosen such that the damage to the battery is avoided. During the charging with the constant current the charging voltage slowly increases. When the charging voltage has reached the maximum value (Vₘₐₓ), commonly 4.1 or 4.2 V in the case of Li-ion batteries, charging is continued with this value of the voltage and with a decreasing value of the current. As stated before the time needed for a full charging of the battery may be long, about two hours.

To shorten this charging time EP-A-1 516 405 discloses the ‘boost’ charging taking place during the first part of the conventional CCCV-charge regime. A diagram of this process is depicted in FIG. 2. Herein initially charging takes place with the maximum voltage, leading to substantial values of the charge current. These large current values are allowable as during these initial charge phases these high currents do not lead to irreversible damage to the battery. A difficulty resides in the determination of the point at which the boost charge should be stopped and the CCCV regime is resumed. To be on the ‘safe side’ the boost charging is stopped rather early, that is well before any chances of damage start to develop.

In FIG. 3 a charger according to the invention is depicted. This charger comprises the normal charger hardware 1, such as a voltage and current regulator and a control unit 2. This control unit will in most cases be implemented in a microprocessor programmed to execute a corresponding program. It is, however, just as well possible to build the functions to be executed by the processor in a dedicated electronic circuit. Just as is the case in the two prior art situations described above, the controller is adapted to control the current and voltage regulator of the charger.

The processor is, however, also adapted to receive the signals representing the charge current (I_{bat}), the charge voltage (U_{bat}) and the temperature of the battery (T_{bat}). The control unit is further adapted to apply a physics-based model on these measured variables to determine the surface concentration of the Li-ions on the positive electrode (X_{Li,pos, surf}), the thickness of the SEI layer on the negative electrode (d_{SEI}) and the State-of-Charge (SoC). The processor is further adapted to use these variables in the determination of the point at which the boost charge is stopped and ‘normal’ CCCV-charge starts.

In this decisive process the processor may use the flow chart depicted in FIG. 4.

This implies that after switching on the charger, the controller determines whether the surface concentration of the Li-ions on the positive electrode (X_{Li,pos,surf}) is larger than 0.5. If this is not the case, the normal CCCV-charge procedure is started.

In the other case the controller subsequently determines whether the thickness of the SEI layer on the negative electrode (d_{SEI}) exceeds a predetermined value. If this is the case, the normal CCCV-charge procedure is started.

In the other case the controller subsequently determines whether the State-of-Charge is higher than a predetermined value. If this is the case, the normal CCCV-charge procedure is started. In the other case the boost charge procedure is started.

In this procedure the applicability of the boost procedure as started is repeatedly determined, preferably with such a frequency that the changes in the calculated values are only limited. Herein it is assumed that each time the procedure is run, freshly calculated values of the surface concentration of the Li-ions on the positive electrode, the thickness of the SEI layer on the negative electrode and the State-of-Charge are available.

The availability of the physics-based model allows a regular check of the accuracy of the values on which the decision to change over from one regime to the other is determined.

Indeed the mode allows as well the calculation of the variables which may be measured as well. This is depicted in FIG. 5, showing a block diagram similar to that of FIG. 3, but wherein the physics-based model is also adapted to generate values for the battery voltage V_{P}, the current Iₚ and the temperature T_{P}. As these values can be measured as well, a comparison gives an indication of the errors ε₁, ε₂, ε₃ of these values in the model. These errors can be used to adapt the model to minimize the errors in a way known per se, but it is also possible to use the values of these errors in the decision process. If these errors exceed a predetermined value, normal boost charging is chosen.

It will be clear that many variations can be applied to the invention. A possibility lies in the use of the values determined by the physical model in another strategy, for instance by giving the charge current such a value that the Li-ion concentration at the positive electrode is maintained close to the border value, allowing an even faster charge under certain circumstances. Of course this principle may be used for other variables.

1. Method of charging a rechargeable unit, such as a rechargeable battery or a rechargeable battery pack,
wherein the charging current is larger than the nominal charging current (C) if at least one condition in the rechargeable unit is met,
characterized in that the at least one condition is continuously calculated from measurable variables of the rechargeable unit through a physics-based model.

2. Method as claimed in claim 1, characterized in that the rechargeable unit is a Li-ion battery.

3. Method as claimed in claim 2, characterized in that one of said conditions is the Li-ion concentration at the positive LiCoO₂-electrode surface (X_{Li,pos,surf}) and that the charging current is larger than the nominal charging current (C) if the Li-ion concentration at the positive LiCoO₂-electrode surface (X_{Li,pos,surf}) is larger than 0.5.

4. Method as claimed in claim 2, characterized in that one of said conditions is the thickness of the SEI layer at the negative electrode (d_{SEI}) and that the charging current is larger than the nominal charging current (C) if the thickness of the SEI layer at the negative electrode (d_{SEI}) is smaller than a predetermined value.

5. Method as claimed in claim 1, characterized in that one of said conditions is the State-of-Charge (SoC) and that the charging current is larger than the nominal charging current (C) if the State-of-Charge (SoC) is smaller than a predetermined value.

6. Method as claimed in claim 1, characterized in that the charging current is determined by the maximum allowable charge voltage of the rechargeable unit if at least one of the conditions is met.

7. Method as claimed in claim 1, characterized in that from the physics-based model at least one measurable value is determined;
that the said value is measured;
that the difference between the measured value and the calculated value is determined; and that another charge procedure is resumed if the resulting difference exceeds a predetermined value.

8. Method as claimed in claim 1, characterized in that at least one of the calculated values is used to adapt parameters of the charge process.

9. Charger for charging a rechargeable unit, such as a rechargeable battery or a rechargeable battery pack, wherein the charger comprises:
a supply unit adapted to supply a charging current to the rechargeable unit;
a controller for controlling the charging current;
wherein the controller is adapted to have the supply unit supply a charging current larger than the nominal charging current (C) if at least one condition in the rechargeable unit is met,
characterized in that the charger comprises:
measuring means for measuring measurable variables of the battery; and
modeling means adapted to calculate continuously said at least one condition from said measured variables.

10. Charger as claimed in claim 9, characterized in that the charger is adapted to charge a Li-ion battery.

11. Charger as claimed in claim 10, characterized in that the modeling means are adapted to model the Li-ion concentration at the positive LiCoO₂-electrode surface (X_{Li,pos,surf}) and that the controller is adapted to have the supply unit supply a charging current larger than the nominal charging current (C) if the Li-ion concentration at the positive LiCoO₂-electrode surface (X_{Li,pos,surf}) is larger than 0.5.

12. Charger as claimed in claim 10, characterized in that the modeling means are adapted to model the thickness of the SEI layer at the negative electrode (d_{SEI}) and that the controller is adapted to have the supply unit supply a charging current larger than the nominal charging current if the thickness of the SEI layer at the negative electrode (d_{SEI}) is smaller than a predetermined value.

13. Charger as claimed in claim 8, characterized in that the modeling means are adapted to model the State-of-Charge (SoC) and that the controller is adapted to have the supply unit supply a charging current larger than the nominal charging current (C) if the State-of-Charge (SoC) is smaller than a predetermined value.

14. Charger as claimed in claim 8, characterized in that the charger is adapted to apply the maximum allowable charge voltage of the rechargeable unit if at least one of said conditions is met.

15. Charger as claimed in claim 10, characterized in that the modeling means are adapted to determine at least one measurable variable;
that the measuring means are adapted to measure said variable;
that the control means are adapted to determine the difference between the measured value and the calculated value; and
that the control means are adapted to resume another charge procedure if the resulting errors exceed a predetermined value.

16. Charger as claimed in claim 15, characterized in that the modeling means are adapted to adapt parameters of the charge process in dependence on the errors.
